(19) United States
(12) Patent Application Publication
(10) Pub. No.: US 2013/0063344 A1
(43) Pub. Date: Mar. 14, 2013

(54) METHOD AND DEVICE FOR THE REMOTE CONTROL OF TERMINAL UNITS

(71) Applicants: Sebastian Obermüller, Munich (DE); Martin Schmalohr, Munich (DE)

(72) Inventors: Sebastian Obermüller, Munich (DE); Martin Schmalohr, Munich (DE)

(73) Assignee: INSTITUT FUR RUNDFUNKTECHNIK GMBH, Munich (DE)

(21) Appl. No.: 13/635,652

(22) PCT Filed: Mar. 14, 2011
(86) PCT No.: PCT/EP2011/053820

§ 371 Date: Oct. 18, 2012

(30) Foreign Application Priority Data
Mar. 15, 2010 (DE) 10 2010 011473.1

(51) Int. Cl. G09G 5/00

(52) U.S. Cl. 345/156

(57) ABSTRACT

For the remote control of terminal units of consumer electronics and of computers by way of a remote control with integrated motion sensors, it is suggested to process the detected motion sequences in the remote control itself and interpret them as gestures to the effect that certain gestures correspond to certain commands which are transmitted from the remote control directly to the corresponding terminal unit or to a computer. (FIG. 2)

### FIELD OF INVENTION

The invention relates to a method for the remote control of terminal units according to the preamble of patent claim 1. Such a method is generally known. The invention also relates to a device for the remote control of terminal units according to the preamble of patent claim 4. Such a device is generally known.

### DESCRIPTIONO F THE PRIOR ART

It is known to control terminal units of consumer electronics, such as e.g. television sets, stereo equipment, DVD players, game consoles and multimedia PCs, by pressing keys on remote controls. A keystroke directly triggers the transmission of a short infrared or near radio signal which is then received by the terminal unit and used for controlling functions. It is moreover known to control video games on game consoles with motion sensitive controllers. Examples of this are the game consoles “Wii” by Nintendo and “Playstation” by Sony. These controllers have micro-electro-mechanical motion sensors and wirelessly transmit measured motion data to the console where they are evaluated and converted into control commands for games and applications.

For personal computers (PC), motion-sensitive peripheral units in the form of remote controls or as presentation aid are also known. Examples of this are the devices “Media Center Remote” by the company Gyration, and “WavIt” by the company ThinkOptics. Such peripheral units permit to control the mouse pointer by moving the remote control. It is furthermore possible to alternatively use some of the above mentioned controllers of game consoles at the PC if they support open communication logs such as Bluetooth. It is furthermore known to control PCs and game consoles without any additional devices exclusively by moving one or two hands. For this control by hand gestures, the shape and the movement of the hands are evaluated by means of cameras. Examples of this are a television set by the company Toshiba, the “EyeToy” camera for the “Playstation” by Sony. In the course of the “Projekt Natal”, the company Microsoft moreover develops an upgrade for the in-house game console “Xbox 360” which is to permit control on the basis of the evaluation of motion sequences of the whole human body.

### SUMMARY OF THE INVENTION

Compared with this, the object of the invention consists in providing a method for the control of terminal units by means of a remote control in which the movement of the remote control is detected and evaluated by the remote control itself. The remote control is thus to be able to autonomously and independently interpret motion sequences of a unit to be controlled as gestures and to convert them into simplified commands for controlling the terminal unit.

According to the invention, this object is achieved by the features of patent claim 1.

Advantageous embodiments and further developments of the method according to the invention can be taken from the method subclaims.

Another object of the invention is a device according to the features of claim 4.

Advantageous embodiments and further developments of the device according to the invention can be taken from the device subclaims.

In contrast to prior art, in the method according to the invention, not the motion information themselves, but only the commands derived from them are to be transmitted to the terminal unit. The interpretation of the movement accordingly no longer, or not exclusively, takes place in the terminal unit, but in the remote control itself As a result, the invention is directed to a functional encapsulation of motion detection in the remote control itself. Thereby, the additional function of gesture-based control can be made without modifying nor extending the communication between the terminal unit and the remote control.

The functional encapsulation of the motion detection in the remote control has an advantage in that no longer the motion data themselves, but only simplified control commands must be transmitted from the remote control to the terminal unit. Thereby, a considerable reduction of the required bandwidth for the transmission of the data can be obtained. Moreover, the method according to the invention permits to employ an energy efficient, non-bidirectional transmission at low data rates. This in turn permits to use, instead of a complex radio connection, the conventional infrared transmission which finds application as industrial standard in nearly all units of entertainment electronics. One can moreover assume that gesture detection altogether is more robust because the motion data do not have to be transmitted before they are detected.

It is thus possible to operate all terminal units that can be controlled with conventional infrared remote controls additionally or exclusively with the aid of gestures. In addition, however, future terminal units can in this manner also be equipped with novel functions. Furthermore, the working mode of the remote control itself can benefit from the method according to the invention by also utilizing unconsciously performed motion sequences, for example for waking up the hand transmitter from a power saving function, which as a consequence could in turn trigger the control of the terminal unit. In addition, the method according to the invention is suited for realizing interactive learning functions in which the remote control offers the user to automatically link typical, frequently carried out motion sequences with important control functions.

### BRIEF DESCRIPTION OF THE DRAWINGS

The invention will be illustrated more in detail below, by way of a mere exemplifying and non limiting example, with reference to the drawings. In the drawings:

FIGS. 1.1 to 1.4 show representations of the translation movement in the X,Y,Z directions as well as the rotary motion about the X,Y,Z axis of a remote control in the non-operative state, in a reference position and during activation when a non-operative threshold value is exceeded, and

FIG. 2 shows a flow chart of the individual steps of the method according to the invention.

### DETAILED DESCRIPTION OF PREFERRED EMBODIMENT

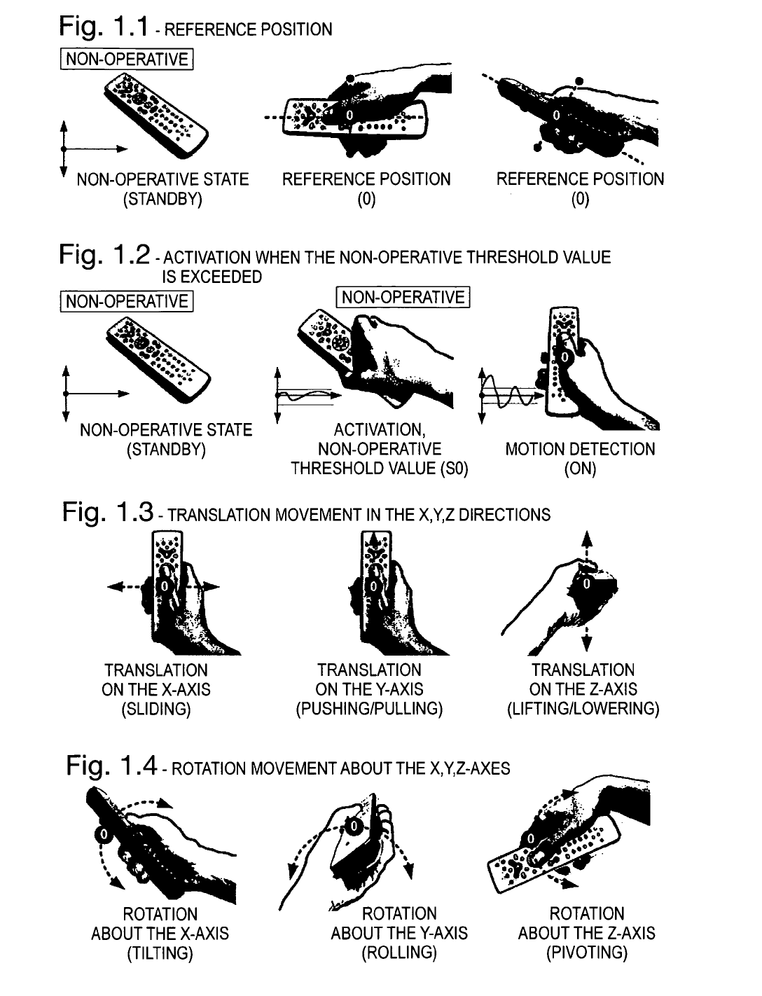

For understanding the representations in FIGS. 1.1 to 1.4, first the used notions will be defined below:

Remote Control

The remote control (RC) is an electronic, battery powered hand-held equipment by means of which units or machines can be operated wirelessly over short to medium distances.

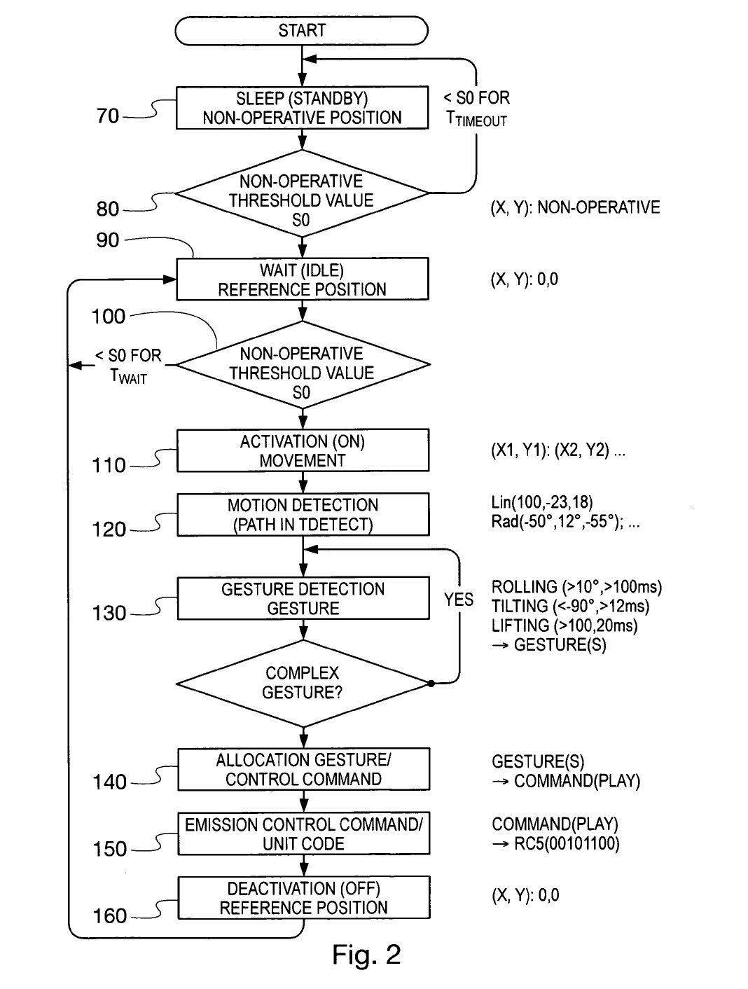

Wireless data transmission is accomplished by means of infrared radiation or radio waves. Reference position (FIG. 1.1 and FIG. 2)

Reference position (0) designates the three-dimensional orientation of the remote control in the room at the starting time (T0) as long as the hand of the user is at rest. The position of a putdown remote control which is not being used is referred to as non-operative position (NON-OPERATIVE). The reference position represents the local and chronological starting value of a GESTURE to be carried out. All movements are evaluated relative to the reference position. An absolute reference point independent of the remote control in the room is not required for the method according to the invention as the reference position is determined anew at the beginning of a detection operation depending on a threshold value or a user input.

Threshold Value (FIG. 1.2 and FIG. 2)

To distinguish between slow and fast movements as well as the stationary case where the remote control is non-operative, threshold values are introduced. The threshold value (S) defines a certain, absolute output value of a technical quantity which is in relation to the movement of the remote control during a limited period (T_{WAIT}, T_{TIMEOUT}). Movements below a non-operative threshold value (S0) to be determined are ignored and no gesture detection takes place (OFF). Thereby, small deflections of the remote control which the user carries out unconsciously or at rest when no control operation is desired are ignored. Movements whose output value exceeds the non-operative threshold value (S0) are used for gesture detection (ON). The non-operative threshold value can furthermore be used for realizing a power-saving mode (STANDBY) to which the remote control changes as soon as it is NON-OPERATIVE. Moreover, additional operating modes are determined by orders of acceleration having different values. As an alternative, gesture detection can also be activated or deactivated by the user himself/herself by a keystroke.

Movement

Movement means a real, single operation carried out by the user consciously or unconsciously with the remote control in the hand. Here, the combined motion sequence of the hand, the arms and the body is considered as uniform process in view of a spatial motion path of the remote control. The remote control here represents an object oriented in the three-dimensional room whose relative position is changed by the user depending on the reference position in six basic movement types. Certain dynamics of the motion sequence, that means each acceleration or a change of the movement type, is interpreted as GESTURE in the process.

Rotation (FIG. 1.4 and FIG. 2)

Each rotation of the remote control about one or several spatial axes (X, Y, Z) relative to the reference position (0) is referred to as rotation. Here, a distinction is made between a rotation about the Z-axis in the horizontal plane (pivoting), the rotation about the X-axis in the vertical plane (tilting), and the rotation about the Y-axis or the longitudinal axis of the remote control (rolling).

Translation (FIG. 1.3 and FIG. 2)

Each linear deflection of the remote control to a certain direction relative to the reference position is referred to as translation. Here, a distinction is made between a vertical translation on the Z-axis (lifting/lowering), the longitudinal translation on the Y-axis away from the body or towards the body (pushing/pulling), and the horizontal translation on the X-axis to the left or to the right (sliding).

Gesture

A completed motion sequence or a certain sequence of several movements is interpreted as GESTURE. For this, changes of the acceleration in the motion sequence are evaluated.

The characteristic dynamics derived from it is allocated to a certain GESTURE. In the sense of the method according to the invention, a distinction is made between simple and complex gestures. A simple GESTURE describes dynamics with only one change of direction. Complex gestures are composed of several simple gestures. The dynamics to a GESTURE can be preprogrammed in the remote control or be programmed by the user himself/herself into the hand-held equipment by the LEARNING MODE during first commissioning or on request. In case of preprogrammed GESTURES, the user must imitate a certain, predetermined motion sequence of the manufacturer. For this, the manufacturer must include a corresponding instruction in the terminal unit or in the documentation which will be referred to as LIST OF GESTURES below. In case of a LEARNING MODE, the user can allocate a completely imaginary, spontaneously carried out GESTURE to a certain control function of his/her terminal unit. A combination of a LIST OF GESTURES and a LEARNING MODE can be accomplished, for example, by means of interactive operator guidance during the initial setup of the terminal unit and/or the remote control.

Hereinafter, the functional sequence of the method according to the invention will be illustrated with reference to FIG. 2. To transmit a control command from the remote control to the terminal unit—starting from the determination of an exceeding of the non-operative threshold value S0 by a decision diamond 100—the following processing steps are carried out:
Activation 110
Motion detection 120
Gesture detection 130
Allocation of a control command 140
Emission of a control code 150
Deactivation 160
Activation (ON) 110

To prevent an unintentional emission of control commands (COMMAND) to the terminal unit, in the decision diamonds 80 and 100, the remote control ignores small movements below the non-operative threshold value (S0) which the user or the surrounding area exert on the hand-held equipment in the non-operative state (OFF). The decision diamond 80 (<S0 for T_{TIMEOUT}) then resets the remote control to the SLEEP (STANDBY) state 70. The decision diamond 100 (<S0 for T_{WAIT}) sets the remote control into the WAIT state (IDLE). As an alternative or in addition, manual activation by a keystroke (“gyro key”, “sensor key”) or suited presence sensors such as proximity switches or touch sensors can be provided by the manufacturer. If it is determined in the decision diamond 100 that the non-operative threshold value S0 was exceeded in a movement of the remote control, the SLEEP (STANDBY) 70 and WAIT (IDLE) 90 states are interrupted by the activation (ON) 110. After the activation, the remote control is ready for receiving movements by the user.

Motion Detection 120

Which GESTURES are allocated to which control commands can be either predetermined by the manufacturer in the remote control or individually allocated by the user/trader. Learned as well as predefined gestures are stored in the remote control as complex or simple motion sequences with certain dynamics. The dynamics of a real motion sequence is understood as a chronological, successive series of sampled values of a motion sensor (GYRO) integrated in the remote control. Whether in the process rotations as well as translations are also evaluated, how many axes the GYRO considers and how fine the time resolution of sampling is selected is up to the manufacturer. Basically, each precise motion detection permits more reliable gesture detection, simultaneously increasing the required computing power and memory requirements in the remote control.

Gesture Detection 130

From the one-, two- or multi-dimensional dynamic motion path recorded in the motion detection 120, characteristic features, such as sequences (STEPS) of certain linear or radial accelerations, for example ROLLING, TILTING, LIFTING, are extracted in the gesture detection 130 after or already during detection. This extraction of a reduced amount of characteristic features represents the essential intelligence of the remote control. Here, it is necessary to reduce the continuous data flow of the GYRO to a few distinctive properties to efficiently design the subsequent allocation to a certain GESTURE. Similar to automatic character recognition, these characteristic features are, when several features match, sorted by means of a reference table (LOOKUPTABLE) and allocated to a certain GESTURE in a LIST OF GESTURES stored in 130. As an alternative to the feature-based detection, a comparing, evaluative algorithm is also conceivable which distinguishes between undetermined sequences with the aid of a neural network.

Allocation of a Control Command 140

By a correspondingly detected GESTURE, a control command determined by the user or manufacturer (COMMAND) beforehand, such as “PLAY”, is triggered which is allocated to a unit code (CODE), such as e.g. “00101100” for the terminal unit. The allocation of various CODES to certain control commands is stored in a Code Table (CODETABLE) stored in 140. The CODEs can be identical to those which are allocated to the command keys (KEYS) of the remote control or which are used for an extension of the scope of functions beyond the available key functions.

Emitting a Unit Code 150

Corresponding to the selected transmission method, the CODE of the control command is encoded as electric signal sequence which is then transmitted to the terminal unit via cable, infrared or high-frequency radio. For transmission, well-known techniques, such as RC-5, RC-6, Bluetooth, X10 or manufacturer-owned log files are possible.

Deactivation 160

After the successful detection of a GESTURE and the complete emission of the corresponding control code in 150, the remote control is in its waiting state (IDLE) 90 to detect further GESTURES or receive key commands by the user. The gesture detection 130 can be carried out in the IDLE state 90 via the deactivation (OFF) 160. If the user starts again to carry out a further GESTURE, the non-operative threshold value S0 is exceeded which is detected by the decision diamond 100. By this, gesture detection is activated again and the cycle of the procedure steps 110, 120, 130, 140, 150 starts from the beginning The time at which the motion path of a GESTURE is terminated is determined by the manufacturer (“preprogrammed”) or by the user (“learning mode”) during the initial setup or on demand at the hand-held equipment. The characteristic features of the dynamics of a certain GESTURE detected in 120 accordingly applies each to a defined period (T_{DETECT}). When the decision diamond 80 determines that the non-operative threshold value S0 has been fallen below over an extended period (T_{TIMEOUT}), the remote control can be set to the power-saving mode Sleep (STANDBY) 70.

The method illustrated with reference to FIG. 2 according to the invention can be extended to a universal or an interactive remote control.

Universal Remote Control

The method according to the invention is in particular suited for improving the using convenience and the extension of the scope of functions of a universal remote control which are offered in trade as a replacement of or an alternative to existing remote controls supplied by the manufacturer together with the terminal units. Such universal remote controls often also offer an integrated change-over function between different operating levels which can be in turn allocated to several different terminal units. The gesture-based control according to the invention can for this be employed as an additional extension or else for a mode or level change. In this manner, gesture detection can be used for several terminal units with only one hand-held equipment. In this context, one particularity is the quasi simultaneous control of several terminal units with only one GESTURE. Upon detection of a certain GESTURE, an allocated control sequence (MACRO) can thus be triggered and transmitted which e.g. switches off all terminal units in the room (TV, stereo, DVD) at a time (AUTO-OFF). It would thus be e.g. conceivable that this function is triggered by simply putting down the remote control “upside down” for an extended period. The GESTURE in this case consists of a ROTATION about the Y-axis (ROLLING) by more than 90 degrees with a subsequent non-operative phase (NON-OPERATIVE). Vice versa, the terminal units can be automatically switched on if the user picks up again the remote control after an extended non-operative phase. The number of controllable terminal units and the amount of control commands a remote control can send depends on the size of its memory and its computing power.

Interactive Remote Control The remote control can moreover contain an interactive learning function which offers the user itself to automatically link typical, frequently carried out motion sequences with important control functions. For this, the utilization of a certain button (LEARN) on the remote control is suggested which can trigger an optical signal (BLINK). The remote control indicates the user by blinking (BLINK) of the button or a display (LEARN) that the GYRO noticed a motion sequence which was already carried out several times with the remote control. By pressing the key LEARN, the user signals the remote control that he now wants to link a certain control function (KEY) or a corresponding CODE, respectively, with the just carried out GESTURE. With a further BLINKing, the remote control signals that as of now, the corresponding GESTURE always automatically emits the desired CODE. In this manner, the user himself/herself could interactively teach e.g. the above mentioned MACRO function AUTO OFF to the universal remote control in a simple manner.

Hereinafter, some practical examples of the control of a television set and a DVD player by moving a remote control operating according to the method of the invention will be given.

Control of a Television set

| | |
|---|---|
| Rotation about the longitudinal axis of the | Turn up the volume |
| remote control to the right, angle of | |
| rotation between 60° and 100° | |
| Rotation about the longitudinal axis of the | Turn down the volume |
| remote control to the left, angle of rotation | |
| between −60° and −100° | |
| Horizontal rotation to the right | Next sender in the sender list |
| Horizontal rotation to the left | Previous sender in the sender |
| | list |

Control of a DVD Player

| | |
|---|---|
| Vertical rotation upwards | Play/Pause |
| Vertical rotation downwards | Stop |
| Horizontal rotation to the right | Next chapter |
| Horizontal rotation to the left | Previous chapter |
| Rotation about the longitudinal axis of the | Forward |
| remote control to the right, angle of | |
| rotation between 60° and 100° | |
| Rotation about the longitudinal axis of the | Rewind |
| remote control to the left, angle of rotation | |
| between −60° and −100° | |

Further implementation details will not be described, as the man skilled in the art is able to carry out the invention starting from the teaching of the above description.

At least a part of the method of the present invention can be advantageously implemented by a program for computer comprising program coding means for the implementation of one or more steps of the method, when this program is running on a computer. Therefore, it is understood that the scope of protection is extended to such a program for computer and in addition to a computer readable means having a recorded message therein, said computer readable means comprising program coding means for the implementation of one or more steps of the method, when this program is run on a computer.

Many changes, modifications, variations and other uses and applications of the subject invention will become apparent to those skilled in the art after considering the specification and the accompanying drawings which disclose preferred embodiments thereof. All such changes, modifications, variations and other uses and applications which do not depart from the spirit and scope of the invention are deemed to be covered by this invention.

1-8. (canceled)

9. Method of controlling terminal units or computers by means of a remote control, wherein the movement of the remote control is detected and converted into control commands,
wherein detected motion sequences are autonomously interpreted by the remote control as gestures and converted into simplified commands for controlling the terminal unit or the computer, to the effect that not the motion information themselves, but only the commands derived from it are transmitted to the terminal unit or the computer,
wherein movements whose absolute output value is below a non-operative treshold value (S0) are ignored (OFF), while movements whose absolute output value exceeds said non-operative treshold value (S0) are used for gesture detection (ON).

10. Method according to claim 9, further providing a learning mode for learning gestures and storing them in the remote control as complex or simple motion sequences with certain dynamics in the form of a LIST OF GESTURES, wherein changes in the acceleration of the motion sequence are evaluated and characteristic features or evaluative distinctions are derived from said changes in acceleration.

11. Method according to claim 10, wherein said derived characteristic features or evaluative distinctions are sorted with reference to a stored reference table (LOOKUPTABLE), wherein a control command of a code table (CODETABLE) for controlling one or several terminal units is in turn individually allocated to each GESTURE in the LIST OF GESTURES.

12. Method according to claim 11, wherein said control command is allocated by said user, by using a learning button (LEARN) on the remote control, which triggers an optical signal (BLINK) indicating to the user by blinking (BLINK) that sensors detected a motion sequence which was already carried out several times with the remote control, and wherein said user by further pressing said learning button (LEARN) signals to the remote control to link a specific control function (KEY, CODE) with the just carried out detected motion sequence.

13. Method according to claim 9 , characterized by the following processing steps:
Activation (110);
Motion detection (120);
Gesture detection (130);
Allocation of a control command (140);
Emission of a control code (150);
Deactivation (160).

14. Device for the remote control of terminal units or computers, comprising:
detecting means for detecting motion sequences of said device for the remote control, and for interpreting said motion sequences as gestures;
converting means for converting said gestures into commands for controlling said terminal unit or computer;
transmitting means for transmitting said commands to said terminal unit or computer;
wherein said device is adapted to implement the method of controlling terminal units or computers according to claim 9.

15. Device for the remote control of terminal units or computers according to claim 14, characterized by further comprising:
storing means for storing gestures, learnt in a learning mode or predefined gestures, as complex or simple motion sequences with certain dynamics in the form of a LIST OF GESTURES;
processing means for processing acceleration variations of said motion sequences and deriving characteristic features or evaluative distinctions;
sorting means for sorting said derived characteristic features or evaluative distinctions with reference to a stored reference table (LOOKUPTABLE) where a control command of a code table (CODETABLE) for controlling one or several of said terminal units or computers is in turn allocated to each gesture in the LIST OF GESTURES.

16. Computer program comprising computer program code means adapted to perform the method of claim 9, when said program is run on a computer.

17. A computer readable medium having a program recorded thereon, said computer readable medium comprising computer program code means adapted to perform the method of claim 9, when said program is run on a computer.

18. Device for the remote control of terminal units or computers, comprising:
detecting means for detecting motion sequences of said device for the remote control, and for interpreting said motion sequences as gestures;
converting means for converting said gestures into commands for controlling said terminal unit or computer;
transmitting means for transmitting said commands to said terminal unit or computer;
wherein said device is adapted to implement the method of controlling terminal units or computers according to claim 10.

19. Device for the remote control of terminal units or computers, comprising:
detecting means for detecting motion sequences of said device for the remote control, and for interpreting said motion sequences as gestures;
converting means for converting said gestures into commands for controlling said terminal unit or computer;
transmitting means for transmitting said commands to said terminal unit or computer;
wherein said device is adapted to implement the method of controlling terminal units or computers according to claim 11.

20. Device for the remote control of terminal units or computers, comprising:
detecting means for detecting motion sequences of said device for the remote control, and for interpreting said motion sequences as gestures;
converting means for converting said gestures into commands for controlling said terminal unit or computer;
transmitting means for transmitting said commands to said terminal unit or computer;
wherein said device is adapted to implement the method of controlling terminal units or computers according to claim 12.

21. Device for the remote control of terminal units or computers, comprising:
detecting means for detecting motion sequences of said device for the remote control, and for interpreting said motion sequences as gestures;
converting means for converting said gestures into commands for controlling said terminal unit or computer;
transmitting means for transmitting said commands to said terminal unit or computer;
wherein said device is adapted to implement the method of controlling terminal units or computers according to claim 13.
